(19) United States
(12) Patent Application Publication
(10) Pub. No.: US 2011/0062939 A1
(43) Pub. Date: Mar. 17, 2011

(54) CONTROLLING POWER USAGE BY AT LEAST ONE ELECTRONIC APPARATUS

(76) Inventor: CHRISTOPHER EDWARD HOOVER, CAMPBELL, CA (US)

(21) Appl. No.: 12/560,172

(22) Filed: Sep. 15, 2009

(51) Int. Cl. H02J 1/00

(52) U.S. Cl. 323/318

(57) ABSTRACT

In a method for controlling power usage by at least one electronic apparatus, a power regulating device having a plurality of integrated power and data connectors is provided. In addition, the at least one electronic apparatus is connected to an integrated power and data connector of the power regulating device with an integrated power and data cord having operational power lines and a data line. Data from the power regulating device is communicated to the at least one electronic apparatus and/or data is received in the power regulating device from the at least one electronic apparatus through the data line, in which the data contains information pertaining to an impending change in power supplied to the at least one electronic apparatus through the operational power lines from the power regulating device.

### CROSS-REFERENCE TO RELATED APPLICATION

The present application shares some common subject matter with PCT Application Serial No. PCT/US09/39041 (Attorney Docket No. 200802259-1), entitled “Determining Power Topology of a Plurality of Computer Systems”, filed on Mar. 31, 2009, the disclosure of which is hereby incorporated by reference in its entirety.

### BACKGROUND

Rack-mounted computer systems offer high computer density for situations utilizing multiple computer systems. In some cases, each rack-mounted computer system has one or more switching power supplies to convert alternating current (AC) power to direct current (DC) power for use. In other cases, the rack mounted computer systems may be “blade servers,” where each blade server selectively plugs into a rack-mounted enclosure, and the blade servers within the enclosure provide DC power from switching power supplies associated with the enclosure as a whole, rather than with particular blade servers.

Regardless of whether computer systems are rack mounted themselves, or blade servers within a rack-mounted enclosure, for high reliability each rack-mounted computer system and/or enclosure for blade servers may have redundant power supplies coupled to different sources of AC power. In the event one source of power fails (for instance, a circuit breaker trips), the computer systems may still remain operational based on the alternate source of power.

### BRIEF DESCRIPTION OF THE DRAWINGS

Embodiments are illustrated by way of example and not limited in the following figure(s), in which like numerals indicate like elements, in which:

FIG. 1A illustrates a simplified block diagram of a system for controlling power usage by at least one electronic apparatus, according to an embodiment of the invention;

FIG. 1B illustrates a simplified partially cross-sectional view of the cord, the integrated power and data connector of the power regulating device, and the integrated power and data connector of the electronic apparatus, according to an embodiment of the invention;

FIG. 2 illustrates a flow diagram of a method for controlling power usage by at least one electronic apparatus, according to an embodiment of the invention;

FIG. 3 illustrates a computer system, which may be employed to perform various functions of the controller depicted in FIG. 1A, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

Disclosed herein is a power regulating device configured to control power usage of as well as data communications to one or more electronic apparatuses through use of one or more integrated power and data cords. Also disclosed herein are a method and system for operating the power regulating device. In one example, the power regulating device is configured to communicate data pertaining to an impending change in the supply of power to the one or more electronic apparatuses through the one or more integrated power and data cords. Thus, instead of requiring a separate communications connection between the power regulating device and the one or more electronic apparatuses, the supply of power and the communications are conducted through one or more integrated power and data cords, thereby reducing the number of cables required between the power regulating device and the one or more electronic apparatuses.

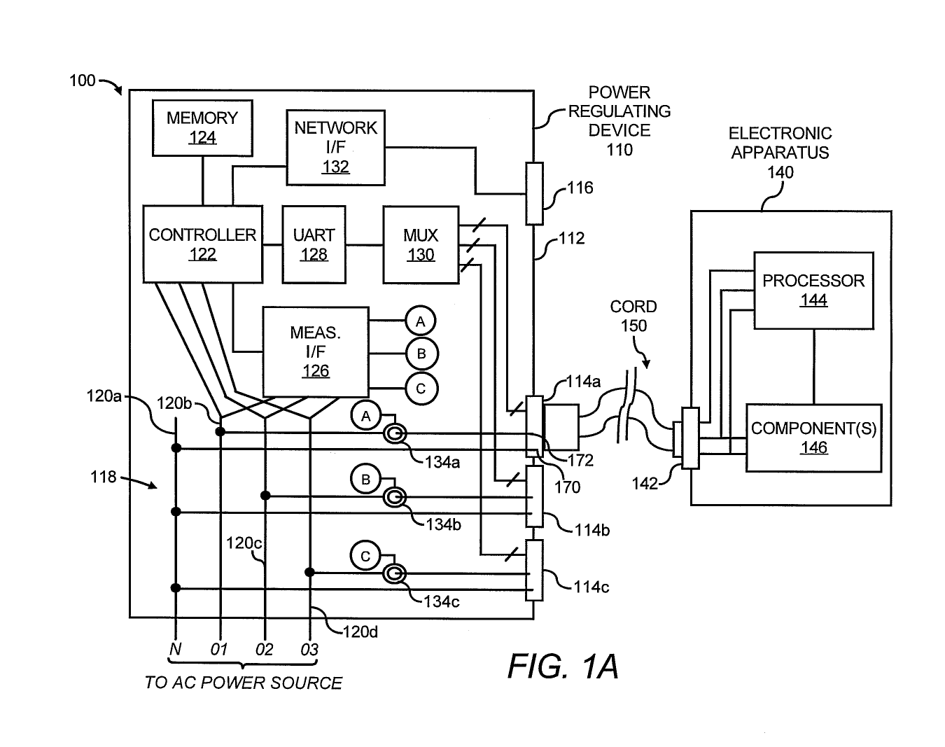

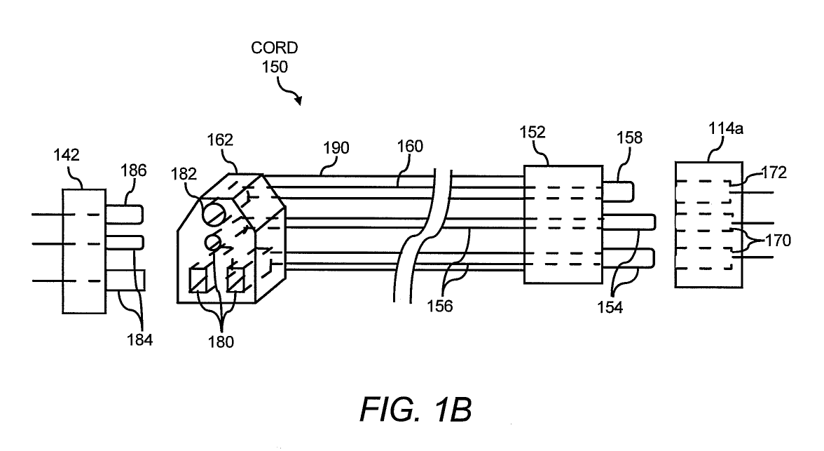

With reference first to FIG. 1A, there is shown a simplified block diagram of a system 100 for controlling power usage by at least one electronic apparatus, according to an example. It should be understood that the following description of the system 100 is but one manner of a variety of different manners in which such a system 100 may be configured. In addition, it should be understood that the system 100 may include additional components and that some of the components described herein may be removed and/or modified without departing from a scope of the system 100.

As depicted in FIG. 1A, the system 100 includes a power regulating device 110, an electronic apparatus 140, and an integrated power and data cord 150. Generally speaking, the power regulating device 110 is configured to supply power through the integrated power and data cord 150 to the electronic apparatus 140. In addition, the power regulating device 110 is also configured to communicate data to and/or from the electronic apparatus 140 through the integrated power and data cord 150. In addition, or alternatively, the power regulating device 110 is configured to receive data from the electronic apparatus 140 through the integrated power and data cord 150.

The power regulating device 110 generally includes an enclosure 112 with an external surface, and a plurality of integrated power and data connectors 114a-114c accessible on the external surface of the enclosure 112. Each integrated power and data connector 114a-114c defines power conductors configured to carry operational power for coupled electronic apparatuses 140, and thus the power connectors of each electrical connector 114a-114c are coupled to the respective source of AC (or DC) power for the power regulating device 110. In some embodiments, each source of AC power is a single phase source of AC power, and in other embodiments, each source of AC power is a three-phase source of AC power.

The power regulating device 110 also includes a data connector 116, which is also accessible on the external surface of the enclosure 112. The data connector 116 is distinguishable from the integrated power and data connectors 114a-114n in that the data connector 116 does not carry AC operational power to an electronic apparatus 140.

As further shown in FIG. 1A, an electronic apparatus 140 is coupled to an integrated power and data connector 114a of the power regulating device 110 and draws operational power through the coupled integrated power and data connector 114a. Although not shown, the system 100 may include a plurality of electronic apparatuses 140 connected to respective integrated power and data connectors 114a-114c of the power regulating device 110.

By way of particular example, the power regulating device 110 comprises a power distribution unit (PDU) and the one or more electronic apparatuses 140 comprise rack-mounted computer systems. As another particular example, the one or more electronic apparatuses 140 comprise appliances, for instance, one or more household appliances, that may benefit from the power usage control discussed herein.

The electronic apparatus 140 is further depicted as being connected to the integrated power and data connector 114a through a cord 150 having integrated operational power and data lines. As such, the cord 150 is configured to carry both operational power from the power regulating device 110 to the electronic apparatus 140 and data, either in a one-way or a two-way communication, between the power regulating device 110 and the electronic apparatus 140. In addition, the integrated power and data connectors 114a-114c are also configured with data connections (not shown) to facilitate the data communication between the power regulating device 110 and the electronic apparatus(es) 140.

Likewise, the electronic apparatus 140 is depicted as including an integrated power and data connector 142 that is configured with both data connections and power connections. As shown, the power lines from the cord 150 are connected to supply power to a processor 144 and components 146, such as, components that consume power in their operations, of the electronic apparatus 140. According to an example, and as discussed in greater detail hereinbelow, data communications pertaining to impending changes in the power supply to the electronic apparatus 140 as well as other types of information may take place between the power regulating device 110 and the processor 144. In response to the receipt of these communications, the processor 124 may initiate operations to prepare the components 146 for a reduction or cessation of power supplied to the electronic apparatus 140. In addition, or alternatively, in response to the receipt of these communications, the processor 124 determine whether to initiate these operations or to communicate a response to the power regulating device 110 that the electronic apparatus 140 is to remain in a current operating state.

As a further alternative, the system 100 includes a controller (not shown) that is external to the power regulating device 110 and the electronic apparatus 140 that determines when to modify the power supplied to the electronic apparatus 140 from the power regulating device 110. In this example, the external controller may communicate instructions to the power regulating device 110 through the data connector 116.

A more detailed discussion of the components contained in the power regulating device 110 and the electronic apparatus 140 is provided herein below. Initially, however, a more detailed discussion of the cord 150 and a manner in which the cord 150 may be inserted into an integrated power and data connector 114a of the power regulating device 110 and into the integrated power and data connector 142 of the electronic apparatus 140 are provided with respect to FIG. 1B.

FIG. 1B, more particularly, shows a simplified partially cross-sectional view of the cord 150, the integrated power and data connector 114a of the power regulating device 110, and the integrated power and data connector 142 of the electronic apparatus 140, according to an example. It should be understood that the following description of the cord 150 and the integrated power and data connectors 114a and 142 may include additional components and that some of the components described herein may be removed and/or modified without departing from scopes of the cord 150 or the integrated power and data connectors 114a and 142.

As shown in FIG. 1B, the integrated power and data connector 114a of the power regulating device 110 includes a plurality of apertures 170 within which conductive material is exposed, and the conductive material is coupled to the source of AC power and thus define conductors configured to carry operational power. In some situations, one conductor is designated as a supply or “hot” conductor, one conductor is designated as the neutral or return, and the third conductor is designated as the safety ground.

The cord end 152 that is configured to engage the electrical connector 114a includes a plurality of blades 154 configured to fit within respective apertures 170 when the cord end 152 is plugged into the integrated power and data connector 114a. In addition, the blades 154 are electrically coupled to power lines 156 in the cord 150. According to some embodiments, the integrated power and data connector 114a and the cord end 152 are based on International Electrotechnical Commission (IEC) chassis sockets and line plugs, such as IEC C20 and C19 respectively; however, other shapes and forms (for instance, IEC C13 line plug and C14 chassis sockets) may be equivalently used. In one regard, therefore, either or both of the power regulating device 110 and the electronic apparatus 140 may be compatible with conventional power cords. In instances where conventional power cords are employed, however, data may not be communicated between the power regulating device 110 and the electronic apparatus 140.

The cord end 152 also includes a data conductor 158 configured to carry data signals through a data line 160 integrally formed in the cord 150. The data conductor 158 is configured to fit within a data aperture 172 of the integrated power and data connector 114a when the cord end 152 is plugged into the integrated power and data connector 114a. The data aperture 172 is configured to send and/or receive data signals to and/or from the data conductor 158. According to an example, the data aperture 172 is configured to communicate optical signals to and/or from the data conductor 158. In this example, the data line 160 and the data conductor 158 comprise fiber optic components, for instance, that are formed of glass or plastic.

The other cord end 162 of the cord 150 is configured to engage the integrated power and data connector 142 of the electronic apparatus 140. As shown, the cord end 162 includes a plurality of apertures 180 within which conductive materials are exposed. In addition, the conductive materials are electrically coupled to the electrical lines 156 contained in the cord 150. The conductive materials may correspond to supply or “hot” conductor, the neutral or return, and the safety ground conductors of the integrated power and data connector 114a of the power regulating device 110.

Moreover, the integrated power and data connector 142 of the electronic apparatus 140 includes a plurality of blades 184 configured to fit within the apertures 182 of the cord end 162 when the cord end 162 is connected to the integrated power and data connector 142. The cord end 162 and the integrated power and data connector 142 may be based on IEC C13 line plug and C14 chassis sockets; however, other line plug and socket configurations may be equivalently used without departing from a scope of the cord 150 disclosed herein.

The cord end 162 also includes a data receptor 182 connected to the data line 160. In addition, the integrated power and data connector 142 includes a data conductor 186 configured to fit within the data receptor 182 when the integrated power and data connector 142 is plugged into the cord end 162. Thus, the connection between the data conductor 186 and the data receptor 182 enables the transmission of, for instance, optical signals through the data line 160.

As further shown in FIG. 1B, the cord 150 includes an outer jacket 190, which operates to protect the power lines 156 and the data line 160. In addition, the data line 160 may be further shielded to reduce loss of optical signals communicated through the data line 160. According to another embodiment, the power lines 156 may have a separate power jacket as compared with the data line 160.

Although the integrated power and data connector 114a of the power regulating device 110 has been depicted as including apertures 170 and 172 and the integrated power and data connector 142 of the electronic apparatus 140 has been depicted as including blades 184 and a data conductor 186, it should be understood that the configurations of the integrated power and data connectors 114a and 142 may be switched with respect to each other without departing from the scope of the system 100 disclosed herein.

Reference is now made back to FIG. 1A to describe the power regulating device 110 and the electronic apparatus 140 in greater detail. Initially, as shown therein, the power regulating device 110 is coupled to a source of AC power. The source of AC power has been depicted as a three-phase source in a “Y” configuration, however delta configurations may be equivalently used. Moreover, in some situations, a single phase AC power source may be used. The phases of the AC power couple to bus conductors 118 within the power regulating device 110. In situations where significant power flows through the power regulating device 110, the bus conductors may be bus bars.

Although FIG. 1A shows three integrated power and data connectors 114a-114n, one for each phase of the AC power source, so as not to unduly complicate the figure; however, in other embodiments each phase of the AC power source may have many power connectors associated therewith. In any regard, each integrated power and data connector 114a-114c has conductors (for instance, conductors contained in the apertures 170 and 172 of electrical connector 114a) that couple to at least some of the bus conductors 118. For example, an integrated power and data connector 114a may couple to the neutral bus conductor 120a and the first phase leg 120b. Likewise, an integrated power and data connector 114b may couple to the neutral conductor 120a and the second phase leg 120c. Finally, integrated power and data connector 114c may couple to the neutral conductor 120a and the third phase leg 120d. In other embodiments where a delta configured AC source is used, the neutral conductor is omitted, and the electrical connectors connect to two of the three phases. Though not shown so as not to unduly complicate the figure, each integrated power and data connector 114a-114c likewise couples to a safety ground conductor.

As also shown in FIG. 1A, the power regulating device 110 further includes a controller 122. The controller 122 may be any suitable controller, such as a processor from the “ARM9” family of processors available from ARM, Inc. of Sunnyvale, Calif. The controller 122 couples to the phase legs 120b-120d of a power source and is configured to control the supply of power to each of the integrated power and data connectors 114a-114c through control of power supplied through each of the phase legs 120b-120d. The controller 122 also couples to a memory 124, which may comprise read only memory (ROM) to store boot code, as well as software that when executed turns the controller 122 into a special-purpose controller, as discussed in greater detail herein below. Further, the memory 124 may comprise random access memory (RAM) to be the working memory for the controller 122. The controller 122 also couples to a measurement interface (I/F) device 126, universal asynchronous receiver/transmitter (UART) 128, multiplexer (MUX) 130, and a network interface 132. Each of these components will be discussed in turn, starting with the UART 128 and the multiplexer 130.

As mentioned above, the power regulating device 110 is configured to communicate with the electronic apparatus 140, which is coupled to an integrated power and data connector 114a, with the communication taking place over data conductors and data lines associated with the integrated power and data connector 114a and power cord 150. In order to facilitate the communication, and in accordance with at least some embodiments, the controller 122 couples to the data conductors contained in the apertures 172 of each power connector by way of the multiplexer 130 and UART 128. According to an example, the communication between the power regulating device 110 and the electronic apparatus 140 is unidirectional, either from the electronic apparatus 140 to the power regulating device 110 or vice versa. The communication may be unidirectional in instances, for example, where either or both of the power regulating device 110 and the electronic apparatus 140 has an alternative communication path, such as, the data connector 116 in the power regulating device 110. In one regard, the unidirectional communication may reduce some costs as compared with the costs associated with bidirectional communication between the power regulating device 110 and the electronic apparatus 140.

Consider, as an example, that the controller 122 first communicates with an electronic apparatus 140 coupled to and drawing operational power through the integrated power and data connector 114a. As part of the communication, the controller 122 may communicate a unique identification (ID) to the electronic apparatus 140 and the electronic apparatus 140 communicates a unique ID back to the controller 122 to enable the controller 122 and the electronic apparatus 140 to identify each other, which may be useful in discovery and topology mapping. The unique ID may be, for instance, IEEE Station Address, a GUID, etc. In this example, the multiplexer 130 may be commanded to communicatively couple the UART 128 to the data conductors associated with the integrated power and data connector 114a. With the multiplexer 130 so configured, the controller 122, by way of the UART 128, communicates with the electronic apparatus 140 coupled to the integrated power and data connector 114a. The communications may be by way of any suitable protocol, for instance, RS232, RS485, etc. Once the controller 122 has concluded the communication with the electronic apparatus 140 coupled to the integrated power and data connector 114a, the multiplexer 130 may be commanded to communicatively couple the UART 128 to the data conductors associated with another integrated power and data connector 114b. Thereafter, the controller 122 may communicate with an electronic apparatus 140 coupled to the integrated power and data connector 114b. In other embodiments, a separate UART device may be present for each integrated power and data connector 114b, and thus the controller 122 may simultaneously communicate with multiple electronic apparatuses.

In addition to the ability to communicate with electronic apparatuses 140 drawing operational power, the power regulating device 110 may also comprise a plurality of current measurement devices disposed within the interior volume defined by the enclosure 112. The current measurement devices are depicted as current transformers 134a-134c. In other embodiments, different current sensing technology, for instance, Hall affect sensors, precision resistors, etc., may be equivalently used. In any regard, each of the current transformers 134a-134c couple to the measurement interface 126. The measurement interface 126 may read the electrical current actually drawn through each integrated power and data connector 114a-114c by way of the respective current transformer 134a-134c. Moreover, in some embodiments, the measurement interface 126 is also coupled to the one or more phases of the AC power source. Thus, the measurement interface 126 may be able to calculate the power drawn by each electronic apparatus 140 through respective integrated power and data connections 114a-114c.

The controller 122 is communicatively coupled to the measurement interface 126, and thus in addition to communicating directly with electronic apparatuses 140 drawing operational power through respective integrated power and data connectors 114a-114c, the controller 122 is also able to obtain data regarding electrical current and/or electrical power drawn by each electronic apparatus 140. Further still, the controller 122 may be programmed to identify which integrated power and data connector 114a-114c couples to which phase of the AC power source, and thus by mere communication with the electronic apparatus 140 may determine the phase through which the electronic apparatus 140 draws operational power.

Various electronic apparatuses 140 are known to include power measurement devices. As such, when the power regulating device 110 is connected to an electronic apparatus 140 having a current measurement device, the current measurement device of the electronic apparatus 140 may be employed to measure the amount of power that the electronic apparatus 140 is consuming. In this example, the power regulating device 110 may receive the measured power consumption level of the electronic apparatus 140 through the power cord 150. In addition, the current measurement device may be omitted from the power regulating device 110, thus reducing the costs associated with fabricating the power regulating device 110.

In addition, the network interface 132 couples to the data connector 116 and the controller 122. In accordance with at least some embodiments, the network interface 132 enables the controller 122 to communicate on local area networks, wide area networks, and/or the Internet in general though the data connector 116. The network interface 132 may implement, for example, Ethernet protocol communication.

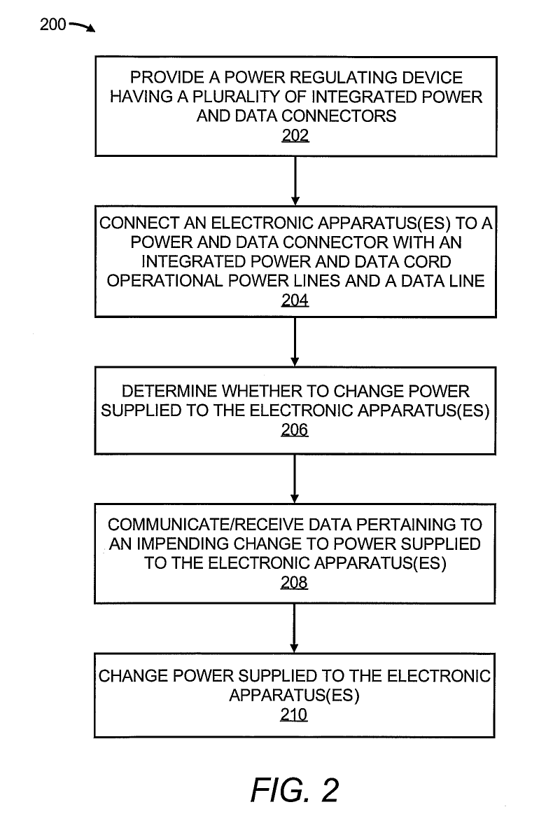

Turning now to FIG. 2, there is shown a flow diagram of a method 200 for controlling power usage by at least one electronic apparatus 140, according to an embodiment. It should be understood that the method 200 depicted in FIG. 2 may include additional steps and that some of the steps described herein may be removed and/or modified without departing from a scope of the method 200.

At step 202, a power regulating device 110 having a plurality of integrated power and data connectors 114a-114c is provided.

At step 204, the at least one electronic apparatus 140 is connected to an integrated power and data connector 114a of the power of regulating device 110 with an integrated power and data cord 150 having operational power lines 156 and a data line 160.

At step 206, the controller 122 of the power regulating device 110 determines whether to change power supplied to the at least one electronic apparatus 140. The controller 122 may determine whether to change the power supplied to the at least one electronic apparatus 140 based upon a predetermined power allocation scheme. More particularly, for instance, the predetermined power allocation scheme may indicate the maximum amount of power that is to be consumed by one or more of the electronic apparatuses 140 at any given time. In this example, the controller 122 may determine that the power supplied to the electronic apparatus 140 connected to the integrated power and data connector 114a is to be ceased at any predetermined time in order to meet the requirements set forth in the predetermined power allocation scheme. Although a particular power allocation scheme has been discussed, it should clearly be understood that the controller 122 may implement power allocation schemes designed to achieve other types of goals.

For instance, the power regulating device 110 may receive a message from a utility through the data connector 116 indicating that the amount of power being supplied to the electronic apparatus 140 is to be reduced. The power regulating device 110 may also receive instructions or messages from another controller via the data connector 116 pertaining to, for instance, a recommended time of when the power regulating device 110 should provide power to the electronic apparatus 140. More particularly, for instance, the other controller may receive pricing information on the power and may determine the recommended time based upon when the power is the least expensive.

In response to a determination that the power supplied to the electronic apparatus 140 is to be changed, at step 208, data containing information pertaining to an impending change in the power supplied to the at least one electronic apparatus is communicated from the power regulating device 110 to the at least one electronic apparatus through the data line 160 in the integrated power and data cord 150. The controller 122 may also communicate data to one or more other electronic apparatuses 140 to inform those other electronic apparatus(es) of an impending power supply change. In addition, the decision of which of the one or more electronic apparatuses to which the data is communicated may be based upon the predetermined power allocation scheme.

The controller 122 may also receive information from one or more electronic apparatuses and may base the determination of whether to communicate the data to the one or more electronic apparatuses upon the information received from the one or more electronic apparatuses. By way of particular example, the controller 122 may receive information pertaining to the operating levels of the components 146 in the one or more electronic apparatuses. In one example, the controller 122 may determine that power supplied to one or more of the electronic apparatuses that are consuming the least amount of power are to be ceased. In another example, the controller 122 may determine that power supplied to one or more of the electronic apparatuses that are consuming the most amount of power are to be ceased. In yet further example, the controller 122 may identify selected ones of the one or more electronic apparatuses for which power supply may be ceased to meet a target power supply level based upon the information received from the one or more electronic apparatuses.

According to an example, the data communicated to the at least one electronic apparatus 140 may include information indicating that the power supplied to the at least one electronic apparatus 140 will be decreased or ceased at a predefined time or after a predefined amount of time has elapsed. In addition, at step 210, the controller 122 may reduce or cease the power supplied through the integrated power and data connector 114a to which the at least one electronic apparatus 140 is connected.

Thus, for instance, the processor 144 of the electronic apparatus 140 may perform one or more operations in preparation of the reduction or cessation in power supplied to the component(s) 146 that consume power in the electronic apparatus 140. According to a particular example in which the electronic apparatus 140 comprises a computer system and the component(s) 146 comprises a hard drive, the processor 144 may cause applications executing on the hard drive to be stored such that data is not lost when power supplied to the electronic apparatus 140 is reduced or ceased.

Some or all of the operations set forth in the method 200 may be contained as one or more utilities, programs, or subprograms, in any desired computer accessible or readable medium. In addition, the method 200 may be embodied by a computer program, which may exist in a variety of forms both active and inactive. For example, it may exist as software program(s) comprised of program instructions in source code, object code, executable code or other formats. Any of the above can be embodied on a computer readable storage medium.

Exemplary computer readable storage devices or media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

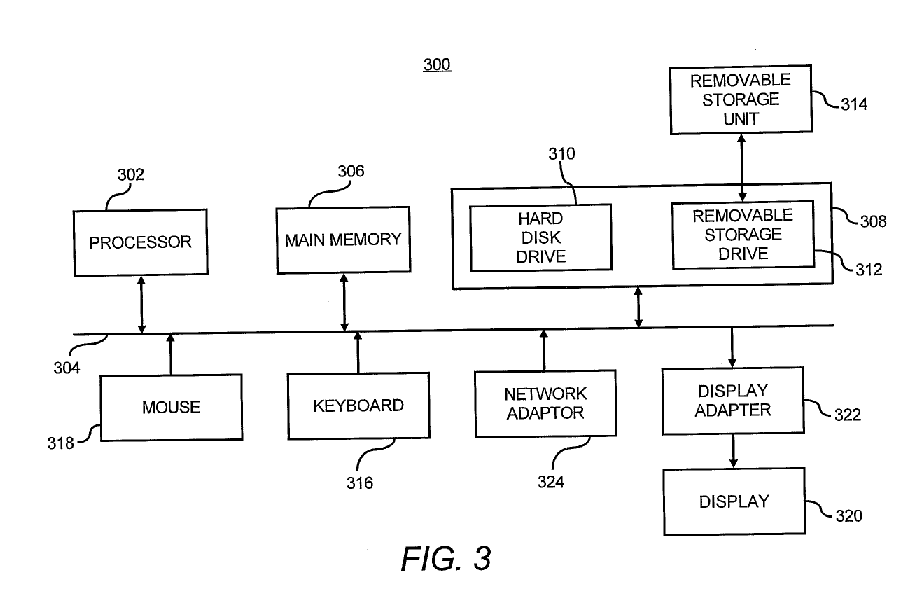

FIG. 3 illustrates a computer system 300, which may be employed to perform the various functions of the controller 122 described herein above with, according to an example. In this respect, the computer system 300 may be used as a platform for executing one or more of the functions described hereinabove with respect to the controller 122.

The computer system 300 includes a processor 302, which may be used to execute some or all of the steps described in the method 200. Commands and data from the processor 302 are communicated over a communication bus 304. The computer system 300 also includes a main memory 306, such as a random access memory (RAM), where the program code may be executed during runtime, and a secondary memory 308. The secondary memory 308 includes, for example, one or more hard disk drives 310 and/or a removable storage drive 312, representing a floppy diskette drive, a magnetic tape drive, a compact disk drive, etc., where a copy of the program code for controlling power usage by at least one electronic apparatus may be stored.

The removable storage drive 310 reads from and/or writes to a removable storage unit 314 in a well-known manner. User input and output devices may include a keyboard 316, a mouse 318, and a display 320. A display adaptor 322 may interface with the communication bus 304 and the display 320 and may receive display data from the processor 302 and convert the display data into display commands for the display 320. In addition, the processor 302 may communicate over a network, for instance, the Internet, LAN, etc., through a network adaptor 324.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for controlling power usage by at least one electronic apparatus, said method comprising:
providing a power regulating device having a plurality of integrated power and data connectors;
connecting the at least one electronic apparatus to an integrated power and data connector of the power regulating device with an integrated power and data cord having operational power lines and a data line; and
at least one of communicating data from the power regulating device to the at least one electronic apparatus and receiving data in the power regulating device from the at least one electronic apparatus through the data line, wherein the data contains information pertaining to an impending change in power supplied to the at least one electronic apparatus through the operational power lines from the power regulating device.

2. The method according to claim 1, further comprising:
changing the power supplied to the at least one electronic apparatus from the power regulating device after a predefined time following communication of the data to the at least one apparatus.

3. The method according to claim 2, wherein changing the power supplied to the at least one electronic apparatus further comprises at least one of reducing and ceasing the supply of power to the at least one electronic apparatus from the power regulating device.

4. The method according to claim 1, wherein communicating data to the electronic apparatus further comprises communicating data to inform the at least one electronic apparatus that the supply of power to the at least one electronic apparatus will cease after a predefined amount of time.

5. The method according to claim 4, further comprising:
in the at least one electronic apparatus, determining whether to permit the power regulating device to cease the supply of power to the at least one electronic apparatus;
communicating data to the power regulating device pertaining to whether or the power regulating device is permitted to cease the supply of power to the at least one electronic apparatus; and
in the power regulating device, ceasing the supply of power to the at least one electronic apparatus after the predetermined amount of time in response to receipt of data indicating that the power regulating device is permitted to cease the supply of power to the at least one electronic apparatus.

6. The method according to claim 4, further comprising:
communicating data from the power regulating device from an external controller indicating that the supply of power to the at least one electronic apparatus will cease after a predefined amount of time;
communicating data from the at least one electronic apparatus to the external controller indicating a condition of the at least one electronic apparatus; and
in the external controller, determining whether to permit the power regulating device to cease the supply of power to the at least one electronic apparatus based upon the data received from the at least one electronic apparatus and communicating an instruction to the power regulating device pertaining to whether the power regulating device is permitted to cease the supply of power to the at least one electronic apparatus.

7. The method according to claim 1, wherein communicating data to the electronic apparatus further comprises communicating a unique identification of the power regulating device to the at least one electronic apparatus, said method further comprising:
communicating a unique identification of the electronic apparatus to the power regulating device.

8. The method according to claim 1, wherein connecting the at least one electronic apparatus further comprises connecting a plurality of electronic apparatuses to respective integrated power and data connectors in the power regulating device with respective integrated power and data cords, each having operational power lines and a data line.

9. The method according to claim 1, further comprising:
determining whether to change the power supplied to the at least one electronic apparatus based upon a predetermined power allocation scheme prior to the step of communicating data to the at least one electronic apparatus of the impending change in the power supplied to the at least one electronic apparatus.

10. The method according to claim 1, further comprising:
communicating information from the at least one electronic apparatus to the power supply device, wherein the power supply device is configured to determine whether to change the power supplied to the at least one electronic apparatus based upon the information received from the at least one electronic apparatus.

11. A system for controlling power usage by at least one electronic apparatus, said system comprising:
a power regulating device having a plurality of integrated power and data connectors, and a controller configured to control power supplied through the plurality of integrated power and data connectors;
an integrated power and data cord connected to the at least one electronic apparatus and the power regulating device, said integrated power and data cord having operational power lines and a data line, wherein the operational power and data lines are connected to an integrated power and data connector; and
wherein the controller is configured to at least one of communicate data to the at least one electronic apparatus and receive data from the at least one electronic apparatus through the data line, wherein the data contains information pertaining to an impending change in power supplied to the at least one electronic apparatus through the operational power lines from the power regulating device.

12. The system according to claim 11, wherein the controller is further configured to change the power supplied to the at least one electronic apparatus after a predefined time following communication of the data to the at least one apparatus.

13. The system according to claim 12, wherein the controller is further configured to at least one of reduce and cease the supply of power to the at least one electronic apparatus from the power regulating device.

14. The system according to claim 11, wherein the controller is further configured to determine whether the power supplied to the at least one electronic apparatus is to be changed based upon a predetermined power allocation scheme and to communicate the data to the at least one electronic apparatus in response to a determination that the predetermined power allocation scheme warrants the change in the power supplied to the at least one electronic apparatus.

15. The system according to claim 11, wherein the power regulating device comprises a power distribution unit and wherein the at least one electronic apparatus comprises a computer system.

16. The system according to claim 11, wherein the data line comprises a fiber optic cable embedded in the integrated power and data cord.

17. The system according to claim 11, wherein the power regulating device is connected to a plurality of electronic apparatuses through respective integrated power and data connectors, each of said integrated power and data connectors having operational power lines and the data line.

18. A power regulating device comprising:
a plurality of integrated power and data connectors, wherein the data connectors comprise connectors for enabling fiber optic communications and wherein the power connectors comprise connectors for enabling operational power supply; and
a controller configured to control power and data supplied through the plurality of integrated power and data connectors, wherein the controller is further configured to at least one of communicate data to at least one electronic apparatus and receive data from the at least one electronic apparatus through the data connector, wherein the data contains information pertaining to an impending change in power supplied to the at least one electronic apparatus through the power connectors of the power regulating device.

19. The power regulating device according to claim 18, wherein the controller is further configured to at least one of reduce and cease the supply of power to the at least electronic apparatus after a predefined time following communication of the data to the at least one apparatus.

20. The power regulating device according to claim 18, wherein the controller is further configured to determine whether the power supplied to the at least one electronic apparatus is to be changed based upon a predetermined power allocation scheme and to communicate the data to the at least one electronic apparatus in response to a determination that the predetermined power allocation scheme warrants the change in the power supplied to the at least one electronic apparatus.
